(19) United States
(12) Patent Application Publication
(10) Pub. No.: US 2026/0054773 A1
(43) Pub. Date: Feb. 26, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TATSUYA ISHIKAWA, TOKYO (JP); YASUHARU SEKI, TOKYO (JP); HIROSHI KAGAWA, TOKYO (JP)

(21) Appl. No.: 19/102,532

(22) PCT Filed: Aug. 1, 2023
(86) PCT No.: PCT/JP2023/028065

§ 371 Date: Feb. 10, 2025

(30) Foreign Application Priority Data
Aug. 18, 2022 (JP) 2022-130441

(51) Int. Cl. B62D 6/00; B62D 1/28

(52) U.S. Cl. CPC B62D 6/008; B62D 1/28

(57) ABSTRACT

The present technology relates to an information processing apparatus, an information processing method, and a program that enable appropriate transmission of steering reaction force to a remote driver.

The information processing apparatus includes a delay time estimation unit configured to estimate, on a basis of vehicle state information, delay time occurring until a vehicle which is a target of remote driving executes, in response to a remote driving operation using an operation unit including a first steering wheel, an action corresponding to the remote driving operation, the vehicle state information being information from the vehicle, indicating a state related to the vehicle, and including one or more pieces of state data having added thereto a timestamp indicating an acquisition time point, and a parameter estimation unit configured to estimate, on a basis of the vehicle state information and the delay time, a model parameter that is a parameter of a model that is used in calculation of a first steering reaction force for the first steering wheel. The present technology can be applied to remote driving systems, for example.

### FIELD

The present technology relates to an information processing apparatus, an information processing method, and a program, and in particular, to an information processing apparatus, an information processing method, and a program suitable for use in a case where remote driving of a vehicle is performed.

### BACKGROUND ART

A driver driving a vehicle can feel steering reaction force transmitted from a steering mechanism, which is mechanically connected to a steering wheel, to act in a direction opposite to an operation direction (rotation direction) of the steering wheel. With this steering reaction force, the driver can feel the condition of a road surface (for example, a friction coefficient (μ), bumps and dips, and the like) and can sequentially adapt the steering of the vehicle to the condition of a road surface.

Meanwhile, in a remote driving system configured to perform the remote driving of a vehicle, the remote driving apparatus that a remote driver uses to perform operations for performing the remote driving of the vehicle (hereinafter referred to as a remote driving operation) is physically separated from the vehicle. Therefore, the steering wheel that the remote driver operates is mechanically disconnected from the steering mechanism of the vehicle. Accordingly, the remote driver cannot feel steering reaction force, which makes it difficult for the remote driver to sequentially adapt the steering of the vehicle to the condition of the road surface.

In contrast to this, in a steer-by-wire steering apparatus, as in remote driving systems, the steering wheel is mechanically disconnected from the steering mechanism. Meanwhile, it has been proposed to apply, in a steer-by-wire steering apparatus, steering reaction force torque calculated on the basis of detection results, such as a steering angle, a vehicle speed, a yaw rate, lateral acceleration, and a road surface friction coefficient, to the steering shaft by an electric motor. With this, the driver can feel steering reaction force in a manner almost similar to that in a case where the steering wheel is mechanically connected to the steering mechanism (for example, see PTL 1).

### CITATION LIST

### Patent Literature

### PTL 1

Japanese Patent Laid-Open No. 2006-137215

### SUMMARY

### Technical Problem

Here, for example, it is conceivable to allow, in a remote driving system, the driver to feel steering reaction force with use of a method similar to that for steer-by-wire steering apparatuses. For example, it is conceivable that the remote driving apparatus calculates steering reaction force torque on the basis of a steering angle, a vehicle speed, a yaw rate, lateral acceleration, and a road surface friction coefficient, for example, detected by sensors installed on the vehicle and applies the steering reaction force torque to the steering shaft of the remote driving apparatus.

However, in this case, since communication between the vehicle and the remote driving apparatus via the Internet or the like is performed, a delay occurs. Due to this delay, a time lag occurs between a timing at which steering reaction force is generated in the vehicle (a timing at which sensor data is detected) and a timing at which the steering reaction force is transmitted to the remote driver. With this, the steering reaction force accurately reflecting the state of the vehicle is not transmitted to the remote driver.

Further, in a case where steering reaction force having a time lag is transmitted to the remote driver, since the actual behavior of the vehicle at a point of time at which the steering reaction force has been transmitted differs from that at the time of the steering reaction force generation, the operation performed by the remote driver on the steering wheel is vibrated. Accordingly, there is a risk that it also becomes difficult to travel while maintaining a straight-traveling state.

The present technology has been made in view of such circumstances and enables appropriate transmission of steering reaction force to a remote driver.

### Solution to Problem

An information processing apparatus according to an aspect of the present technology includes a delay time estimation unit configured to estimate, on the basis of vehicle state information, delay time occurring until a vehicle which is a target of remote driving executes, in response to a remote driving operation using an operation unit including a first steering wheel, an action corresponding to the remote driving operation, the vehicle state information including information from the vehicle, indicating a state related to the vehicle, and including one or more pieces of state data having added thereto a timestamp indicating an acquisition time point, and a parameter estimation unit configured to estimate, on the basis of the vehicle state information and the delay time, a model parameter that includes a parameter of a model that is used in calculation of a first steering reaction force for the first steering wheel.

An information processing method according to an aspect of the present technology includes estimating, by an information processing apparatus, on the basis of vehicle state information, delay time occurring until a vehicle which is a target of remote driving executes, in response to a remote driving operation using an operation unit including a steering wheel, an action corresponding to the remote driving operation, the vehicle state information including information from the vehicle, indicating a state related to the vehicle, and including one or more pieces of state data having added thereto a timestamp indicating an acquisition time point, and estimating, by the information processing apparatus, on the basis of the vehicle state information and the delay time, a model parameter that includes a parameter of a model that is used in calculation of steering reaction force for the steering wheel.

A program according to an aspect of the present technology causes a computer to execute processing of estimating, on the basis of vehicle state information, delay time occurring until a vehicle which is a target of remote driving executes, in response to a remote driving operation using an operation unit including a steering wheel, an action corresponding to the remote driving operation, the vehicle state information including information from the vehicle, indicating a state related to the vehicle, and including one or more pieces of state data having added thereto a timestamp indicating an acquisition time point, and estimating, on the basis of the vehicle state information and the delay time, a model parameter that includes a parameter of a model that is used in calculation of steering reaction force for the steering wheel.

In an aspect of the present technology, on the basis of vehicle state information, delay time occurring until a vehicle which is a target of remote driving executes, in response to a remote driving operation using an operation unit including a steering wheel, an action corresponding to the remote driving operation is estimated, the vehicle state information being information from the vehicle, indicating a state related to the vehicle, and including one or more pieces of state data having added thereto a timestamp indicating an acquisition time point, and on the basis of the vehicle state information and the delay time, a model parameter that is a parameter of a model that is used in calculation of steering reaction force for the steering wheel is estimated.

### BRIEF DESCRIPTION OF DRAWINGS

FIG. 1 is a block diagram illustrating an embodiment of a remote driving system to which the present technology is applied.

FIG. 2 is a block diagram illustrating a configuration example of a remote driving apparatus of the remote driving system of FIG. 1.

FIG. 3 is a block diagram illustrating a configuration example of a vehicle of the remote driving system of FIG. 1.

FIG. 4 is a flowchart illustrating processing of the remote driving system.

FIG. 5 is a block diagram illustrating a configuration example of a computer.

### DESCRIPTION OF EMBODIMENTS

Now, an embodiment of the present technology is described. The description is given in the following order.
1. Embodiment
2. Modified example
3. Others

### 1. Embodiment

### Configuration Example of Remote Driving System 1

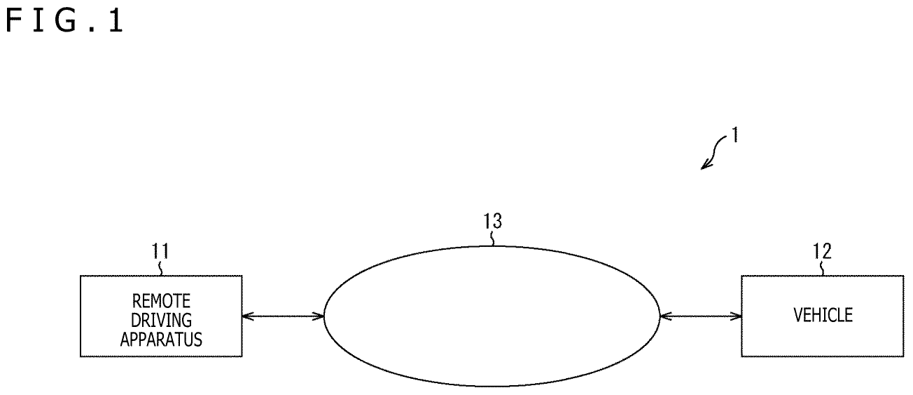

### FIG. 1 illustrates an embodiment of a remote driving system 1 to which the present technology is applied.

The remote driving system 1 includes a remote driving apparatus 11 that a remote driver uses to perform remote driving and a vehicle 12 which is a target of remote driving. The remote driving apparatus 11 and the vehicle 12 are connected to each other via a network 13 such as the Internet and can communicate with each other.

Here, remote driving refers to, for example, executing, from a remote location, part or all of the DDT (Dynamic Driving Task) and/or the fallback of the DDT for the vehicle 12 in real-time. The DDT includes, for example, braking, steering, acceleration, and transmission shifting.

The remote driving apparatus 11 includes, for example, an operation unit for the remote driver to perform remote driving operations of the vehicle 12, a display unit configured to present the situation around the vehicle 12 to the remote driver, and the like.

For example, the remote driver operates the operation unit while monitoring the situation around the vehicle 12 presented on the display unit, to execute the remote driving of the vehicle 12.

Specifically, for example, the remote driving apparatus 11 generates a vehicle control signal including control information regarding the vehicle 12 on the basis of a remote driving operation on the operation unit by the remote driver. The remote driving apparatus 11 transmits the vehicle control signal to the vehicle 12 via the network 13.

In response to this, the vehicle 12 executes an action based on the vehicle control signal. Accordingly, the vehicle 12 operates according to the operation performed by the remote driver.

Further, the vehicle 12 transmits vehicle state information indicating a state related to the vehicle 12 to the remote driving apparatus 11 via the network 13. The state related to the vehicle 12 includes the state of the vehicle 12 and the situation around the vehicle 12.

In response to this, the display unit of the remote driving apparatus 11 presents the situation around the vehicle 12 to the remote driver on the basis of the vehicle state information.

Further, the remote driving apparatus 11 updates parameters of a model (hereinafter referred to as a model parameter) configured to generate steering reaction force, on the basis of the vehicle state information. The remote driving apparatus 11 uses the model and the model parameters to calculate (simulate) steering reaction force with a predetermined algorithm on the basis of the operation performed by the remote driver on the steering wheel included in the operation unit. The remote driving apparatus 11 applies the torque corresponding to the calculated steering reaction force to the steering shaft to transmit the steering reaction force to the remote driver.

### Configuration Example of Remote Driving Apparatus 11

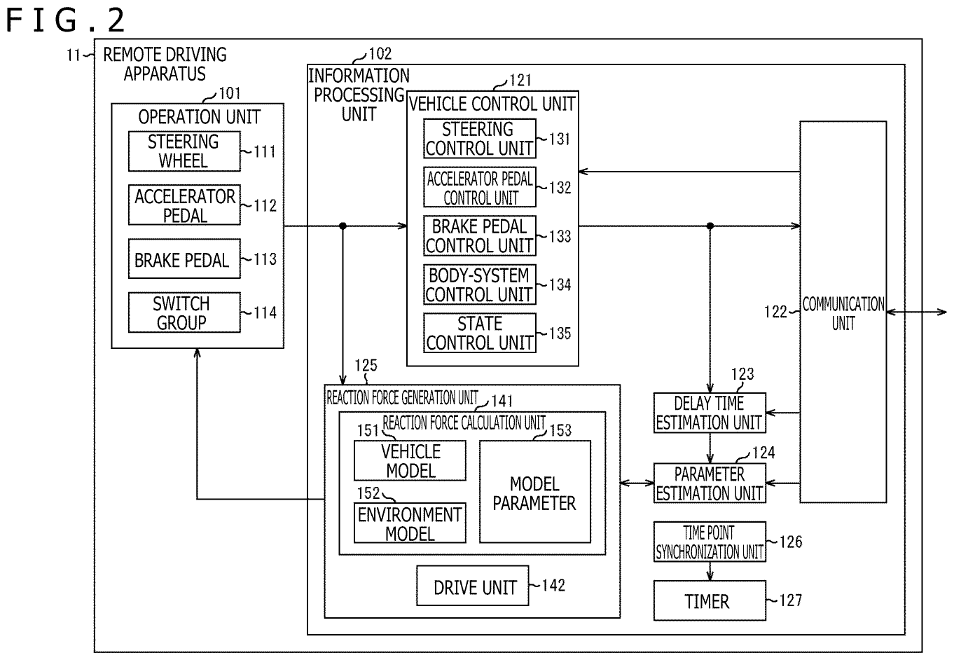

FIG. 2 illustrates a part of a configuration example of the remote driving apparatus 11.

Note that FIG. 2 mainly illustrates a section that the remote driver operates and a section configured to transmit steering reaction force to the remote driver, while the illustration of other sections (for example, a section configured to present the situation around the vehicle 12 and the like) is omitted as appropriate.

The remote driving apparatus 11 includes an operation unit 101 and an information processing unit 102.

The operation unit 101 includes operation devices that the remote driver operates to execute the remote driving of the vehicle 12. For example, the operation unit 101 includes a steering wheel 111, an accelerator pedal 112, a brake pedal 113, and a switch group 114.

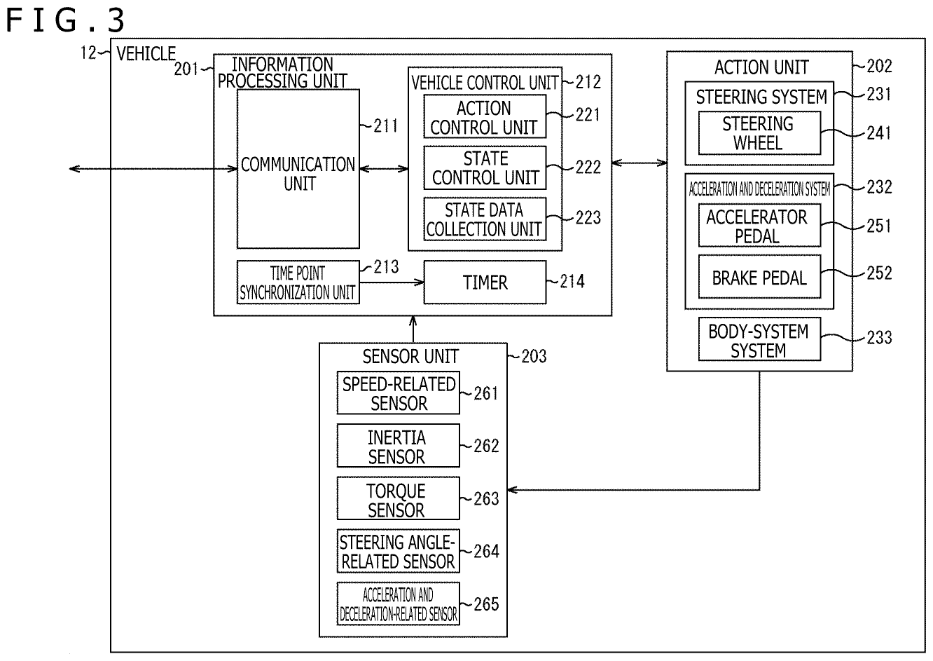

The steering wheel 111 is operated by the remote driver in place of a steering wheel 241 (FIG. 3) of the vehicle 12 in order to steer the vehicle 12.

The accelerator pedal 112 is operated by the remote driver in place of an accelerator pedal 251 (FIG. 3) of the vehicle 12 in order to accelerate the vehicle 12.

The brake pedal 113 is operated by the remote driver in place of a brake pedal 252 (FIG. 3) of the vehicle 12 in order to decelerate the vehicle 12.

The switch group 114 includes operation devices such as switches that are used to start and end remote driving, as well as to operate a body-system system 233 (FIG. 3) of the vehicle 12.

The operation unit 101 supplies operation signals indicating operation contents of each operation device to a vehicle control unit 121 and a reaction force generation unit 125 of the information processing unit 102.

The information processing unit 102 is implemented by, for example, a processor such as a CPU (Central Processing Unit), a memory, or the like. The information processing unit 102 executes various types of processing related to the remote driving of the vehicle 12. The information processing unit 102 includes the vehicle control unit 121, a communication unit 122, a delay time estimation unit 123, a parameter estimation unit 124, the reaction force generation unit 125, a time point synchronization unit 126, and a timer 127.

The vehicle control unit 121 remotely controls the action and state of the vehicle 12. The vehicle control unit 121 includes a steering control unit 131, an accelerator pedal control unit 132, a brake pedal control unit 133, a body-system control unit 134, and a state control unit 135.

The steering control unit 131 remotely controls the action of a steering system 231 (FIG. 3) of the vehicle 12. For example, the steering control unit 131 sets target values for a steering angle and a steering speed of the steering wheel 241 (FIG. 3) of the steering system 231 of the vehicle 12 on the basis of an operation on the steering wheel 111. The steering control unit 131 generates a steering command including control information that indicates the set target values and is associated with a remote operation of the steering wheel 241.

The accelerator pedal control unit 132 remotely controls the acceleration action of an acceleration and deceleration system 232 (FIG. 3) of the vehicle 12. For example, the accelerator pedal control unit 132 sets a target value for the position of the accelerator pedal 251 (FIG. 3) of the acceleration and deceleration system 232 of the vehicle 12 on the basis of an operation on the accelerator pedal 112. The accelerator pedal control unit 132 generates an accelerator pedal command including control information that indicates the set target value and is associated with a remote operation of the accelerator pedal 251.

The brake pedal control unit 133 remotely controls the deceleration action of the acceleration and deceleration system 232 (FIG. 3) of the vehicle 12. For example, the brake pedal control unit 133 sets a target value for the pedal effort or position of the brake pedal 252 (FIG. 3) of the acceleration and deceleration system 232 of the vehicle 12 on the basis of an operation on the brake pedal 113. The brake pedal control unit 133 generates a brake pedal command including control information that indicates the set target value and is associated with a remote operation of the brake pedal 252.

The body-system control unit 134 remotely controls the action of the body-system system 233 (FIG. 3) of the vehicle 12. For example, the body-system control unit 134 sets instructions, set values, target values, and the like for the action of the body-system system 233 of the vehicle 12 on the basis of an operation on the switch group 114. The body-system control unit 134 generates a body-system command including control information indicating the instructions, set values, target value, and the like which have been set.

The vehicle control unit 121 generates vehicle control signals including steering commands, accelerator pedal commands, brake pedal commands, and body-system commands. The vehicle control unit 121 transmits the vehicle control signals to the vehicle 12 via the communication unit 122 and the network 13 and also supplies the vehicle control signals to the delay time estimation unit 123.

The state control unit 135 remotely controls the state of the remote driving of the vehicle 12. For example, the state control unit 135 generates a signal requesting the start of remote driving (hereinafter referred to as a remote driving start request signal) or a signal requesting the end of remote driving (hereinafter referred to as a remote driving end request signal), on the basis of an operation on the switch group 114. The state control unit 135 transmits the remote driving start request signal or the remote driving end request signal to the vehicle 12 via the communication unit 122 and the network 13. Further, in a case where the vehicle 12 approves the start of remote driving, the state control unit 135 receives a remote driving start approval signal from the vehicle 12 via the network 13 and the communication unit 122.

The communication unit 122 communicates with a communication unit 211 (FIG. 3) of the vehicle 12 via the network 13.

Note that the communication method between the communication unit 122 of the remote driving apparatus 11 and the communication unit 211 of the vehicle 12 is not necessarily limited to one type. For example, two or more different types of communication methods may be used depending on the situation.

The delay time estimation unit 123 receives vehicle state information from the vehicle 12 via the network 13 and the communication unit 122. The delay time estimation unit 123 estimates delay time from execution of the remote driving operation with use of the operation unit 101 to execution of the action that is performed by the vehicle 12 and that corresponds to the remote driving operation (hereinafter referred to as action delay time), on the basis of the vehicle state information and a vehicle control signal supplied from the vehicle control unit 121. The delay time estimation unit 123 supplies information indicating the estimation result of the action delay time to the parameter estimation unit 124.

The parameter estimation unit 124 receives vehicle state information from the vehicle 12 via the network 13 and the communication unit 122. The parameter estimation unit 124 estimates a model parameter 153 of a reaction force calculation unit 141 on the basis of the vehicle state information and the action delay time. The parameter estimation unit 124 updates the current model parameter 153 of the reaction force calculation unit 141 with the estimated model parameter 153.

The reaction force generation unit 125 generates steering reaction force to be applied to the steering wheel 111, on the basis of operation control signals supplied from the operation unit 101. The reaction force generation unit 125 includes the reaction force calculation unit 141 and a drive unit 142.

The reaction force calculation unit 141 calculates (simulates) steering reaction force for an operation on the steering wheel 111 with a predetermined algorithm by using a vehicle model 151, an environment model 152, and the model parameter 153. Further, the reaction force calculation unit 141 calculates torque to be applied to the steering shaft (not illustrated) (hereinafter referred to as steering reaction force torque), which is connected to the steering wheel 111, in order to apply the steering reaction force to the steering wheel 111.

The vehicle model 151 is a model that models the vehicle 12.

The environment model 152 is a model that models the environment around the vehicle 12. The environment around the vehicle 12 includes, for example, the condition of a road surface on which the vehicle 12 travels.

The model parameter 153 is a parameter that is used in the vehicle model 151 and the environment model 152. The model parameter 153 includes, for example, parameters indicating the specifications of the vehicle 12 and parameters indicating the environment around the vehicle 12.

Further, the model parameter 153 includes parameters that affect steering reaction force, which are parameters indicating the specifications of the vehicle 12 or parameters indicating the environment around the vehicle 12. For example, the model parameter 153 includes parameters indicating the tire air pressure of the vehicle 12 and the condition of the road surface (for example, a friction coefficient (u), road surface bumps and dips, and the like) on which the vehicle 12 travels.

The drive unit 142 includes, for example, an actuator configured to apply steering reaction force torque to the steering shaft. The drive unit 142 controls the actuator and the like to apply, to the steering shaft, steering reaction force torque calculated by the reaction force calculation unit 141, to transmit the steering reaction force to the remote driver operating the steering wheel 111.

The time point synchronization unit 126 sets, for example, the time point of the timer 127 to Coordinated Universal Time (UTC) on the basis of signals received from GNSS (Global Navigation Satellite System) positioning satellites, to synchronize the timer 127 with a timer 214 (FIG. 3) of the vehicle 12.

The timer 127 supplies time point information indicating the current time point to each part of the remote driving apparatus 11.

### Configuration Example of Vehicle 12

FIG. 3 illustrates a part of a configuration example of the vehicle 12.

Note that FIG. 3 mainly illustrates a section of the vehicle 12 configured to perform remote driving processing, and the illustration of other sections is omitted as appropriate.

The vehicle 12 includes an information processing unit 201, an action unit 202, and a sensor unit 203.

The information processing unit 201 includes, for example, an ECU (Electronic Control Unit) and the like and executes processing related to the remote driving of the vehicle 12, for example. The information processing unit 201 includes the communication unit 211, a vehicle control unit 212, a time point synchronization unit 213, and the timer 214.

The communication unit 211 communicates with the communication unit 122 of the remote driving apparatus 11 via the network 13. Further, the communication unit 211 supplies, to the vehicle control unit 212, information indicating the communication status with the remote driving apparatus 11.

The vehicle control unit 212 controls the action of the vehicle 12 operated by remote driving. The vehicle control unit 212 includes an action control unit 221, a state control unit 222, and a state data collection unit 223.

The action control unit 221 receives vehicle control signals from the remote driving apparatus 11 via the network 13 and the communication unit 211. The action control unit 221 controls the actions of each part of the action unit 202 on the basis of the vehicle control signals.

The state control unit 222 receives remote driving start request signals or remote driving end request signals via the network 13 and the communication unit 211. In a case where the state control unit 222 receives a remote driving start request signal, the state control unit 222 checks permission conditions for remote driving. In a case where the state control unit 222 determines to permit remote driving, the state control unit 222 generates a remote driving start approval signal and transmits the remote driving start approval signal to the remote driving apparatus 11 via the communication unit 211 and the network 13.

The state data collection unit 223 collects state data indicating a state related to the vehicle 12 from the communication unit 211, the action unit 202, and the sensor unit 203. Each piece of state data indicates, for example, the state of the vehicle 12 or the situation around the vehicle 12. The state data collection unit 223 uses the timer 214 to add a timestamp indicating an acquisition time point of the state data to the corresponding state data. The state data collection unit 223 generates vehicle state information including the collected state data and transmits the vehicle state information to the remote driving apparatus 11 via the communication unit 211 and the network 13.

The time point synchronization unit 213 sets, for example, the time point of the timer 214 to Coordinated Universal Time on the basis of signals received from GNSS positioning satellites, to synchronize the timer 214 with the timer 127 of the remote driving apparatus 11.

The action unit 202 executes various actions of the vehicle 12. Further, the action unit 202 supplies information indicating the states of each part of the action unit 202 to the information processing unit 201. The action unit 202 includes the steering system 231, the acceleration and deceleration system 232, and the body-system system 233.

The steering system 231 includes the steering wheel 241, an electric power steering apparatus (not illustrated), and the like, and executes the steering control of the vehicle 12.

The acceleration and deceleration system 232 includes the accelerator pedal 251, the brake pedal 252, and an apparatus configured to control the acceleration and deceleration of the vehicle 12 (for example, at least one of an engine and a motor, a PDU (Power Drive Unit), or ESC (Electronic Stability Control)), and executes the acceleration and deceleration control of the vehicle 12.

The body-system system 233 includes, for example, a keyless entry system, a smart key system, a power window apparatus, power seats, an air conditioning apparatus, airbags, seatbelts, a shift lever, various types of lights, and a car horn.

The sensor unit 203 performs sensing of a state related to the vehicle 12. The sensor unit 203 includes a speed-related sensor 261, an inertia sensor 262, a torque sensor 263, a steering angle-related sensor 264, and an acceleration and deceleration-related sensor 265.

The speed-related sensor 261 detects, for example, the speed of the vehicle 12 and the speed of each wheel. The speed-related sensor 261 supplies sensor data indicating the detection results to the information processing unit 201.

The inertia sensor 262 detects, for example, the yaw rate and lateral acceleration of the vehicle body of the vehicle 12. The inertia sensor 262 supplies sensor data indicating the detection results to the information processing unit 201.

The torque sensor 263 detects, for example, torque applied to the steering shaft connected to the steering wheel 241. The torque applied to the steering shaft is a composite torque of torque applied under the control of the action control unit 221 in response to remote driving operations and torque transmitted from the road surface through the tires of the vehicle 12 and the like (steering reaction force torque). The torque sensor 263 supplies sensor data indicating the detection result to the information processing unit 201. Note that, depending on the placement of the torque sensor 263 or whether the steering is performed by automatic steering with electric power steering or by an external automatic steering system, the motor drive torque may be used as steering reaction force torque.

The steering angle-related sensor 264 detects, for example, the steering angle and steering angle speed of the steering wheel 241. The steering angle-related sensor 264 supplies sensor data indicating the detection results to the information processing unit 201.

The acceleration and deceleration-related sensor 265 detects, for example, the acceleration and deceleration of the vehicle 12. The acceleration and deceleration-related sensor 265 supplies sensor data indicating the detection results to the information processing unit 201.

### Processing of Remote Driving System 1

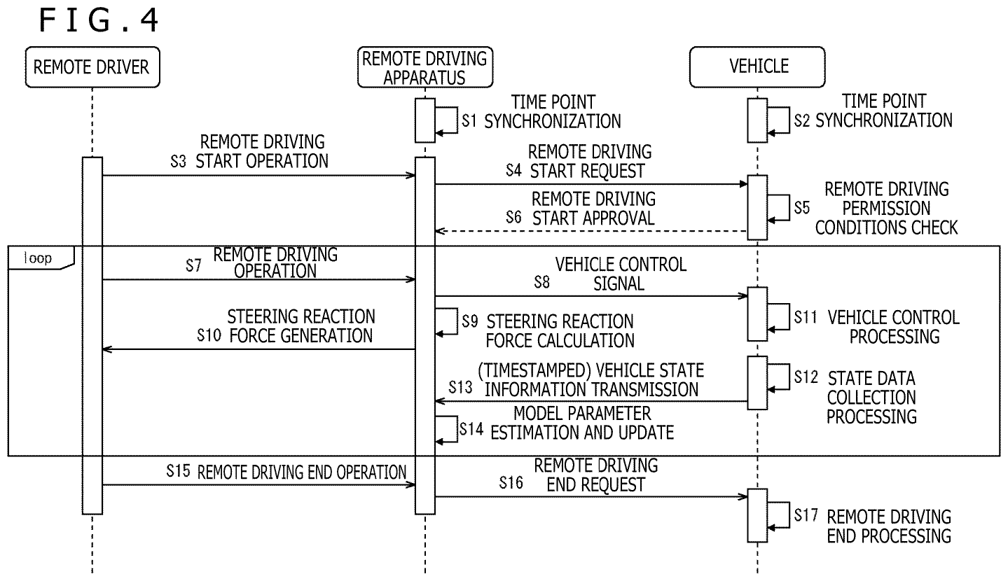

Next, with reference to the sequence diagram of FIG. 4, the processing of the remote driving system 1 is described.

Note that FIG. 4 is a sequence diagram between the remote driver, the remote driving apparatus 11, and the vehicle 12.

In Step S1, the time point synchronization unit 126 of the remote driving apparatus 11 executes time point synchronization. For example, the time point synchronization unit 126 sets the time point of the timer 127 to Coordinated Universal Time on the basis of signals received from GNSS positioning satellites.

In Step S2, the time point synchronization unit 213 of the vehicle 12 executes time point synchronization. For example, the time point synchronization unit 213 sets the time point of the timer 214 to Coordinated Universal Time (UTC) by a method similar to that for the time point synchronization unit 126 of the remote driving apparatus 11.

Through the processing of Step S1 and Step S2, the time point of the timer 127 of the remote driving apparatus 11 is synchronized with the time point of the timer 214 of the vehicle 12.

Note that the processing of Step S1 and the processing of Step S2 may be performed in the reversed order or simultaneously.

Further, for example, in a case where the remote driving apparatus 11 and the vehicle 12 are in the same time zone, the time points of the timer 127 and the timer 214 may be set to the standard time of that time zone. Meanwhile, in a case where the remote driving apparatus 11 and the vehicle 12 are in different time zones, for example, the time points of the timer 127 and the timer 214 may be set to the standard time of any one of the time zones.

Further, as the method of synchronizing the time point of the timer 127 with the time point of the timer 214, methods other than that described above can be adopted.

In Step S3, the remote driving apparatus 11 receives a start operation for remote driving.

For example, in a case where the remote driver starts remote driving, the remote driver uses the switch group 114 of the remote driving apparatus 11 to perform an operation for starting remote driving. The switch group 114 supplies an operation signal instructing the start of remote driving to the vehicle control unit 121.

In Step S4, the remote driving apparatus 11 requests the vehicle 12 to start the remote driving. Specifically, the state control unit 135 of the remote driving apparatus 11 generates a remote driving start request signal and transmits the remote driving start request signal to the vehicle 12 via the communication unit 122 and the network 13.

In response to this, the vehicle control unit 212 of the vehicle 12 receives the remote driving start request signal from the remote driving apparatus 11 via the network 13 and the communication unit 211.

In Step S5, the state control unit 222 of the vehicle 12 checks permission conditions for remote driving. Specifically, the state control unit 222 checks conditions that are used to determine whether to permit remote driving or not, on the basis of the state of the action unit 202 and the like. Then, in a case where it is determined to permit the remote driving, the processing proceeds to Step S6.

Note that, in a case where it is determined not to permit the remote driving, the remote driving is not performed and the processing ends.

In Step S6, the vehicle 12 approves the start of remote driving. Specifically, the state control unit 222 of the vehicle 12 sets the vehicle 12 to a state in which the vehicle 12 is ready for remote driving. The state control unit 222 generates a remote driving start approval signal and transmits the remote driving start approval signal to the remote driving apparatus 11 via the communication unit 211 and the network 13.

In response to this, the vehicle control unit 121 of the remote driving apparatus 11 receives the remote driving start approval signal via the network 13 and the communication unit 122.

In Step S7, the remote driving apparatus 11 receives a remote driving operation.

Specifically, the remote driver appropriately operates the steering wheel 111, the accelerator pedal 112, the brake pedal 113, and the switch group 114 of the remote driving apparatus 11 to execute a remote driving operation of the vehicle 12.

In response to this, the operation unit 101 supplies operation signals indicating operation contents of each operation device to the vehicle control unit 121 and the reaction force generation unit 125.

In Step S8, the remote driving apparatus 11 transmits a vehicle control signal to the vehicle 12.

For example, the steering control unit 131 sets target values for the steering angle and steering speed of the steering wheel 241 of the vehicle 12 on the basis of the operation on the steering wheel 111. The steering control unit 131 generates a steering command including control information indicating the set target values.

The accelerator pedal control unit 132 sets a target value for the position of the accelerator pedal 251 of the vehicle 12 on the basis of the operation on the accelerator pedal 112. The accelerator pedal control unit 132 generates an accelerator pedal command including control information indicating the set target value.

The brake pedal control unit 133 sets a target value for the pedal effort or position of the brake pedal 252 of the vehicle 12 on the basis of the operation on the brake pedal 113. The brake pedal control unit 133 generates a brake pedal command including control information indicating the set target value.

The body-system control unit 134 sets instructions, set values, target values, and the like for the action of the body-system system 233 of the vehicle 12 on the basis of the operation on the switch group 114. The body-system control unit 134 generates a body-system command including control information indicating the instructions, set values, target values, and the like which have been set.

The vehicle control unit 121 generates a vehicle control signal including the steering command, the accelerator pedal command, the brake pedal command, and the body-system command. The vehicle control unit 121 transmits the vehicle control signal to the vehicle 12 via the communication unit 122 and the network 13 and also supplies the vehicle control signal to the delay time estimation unit 123.

The delay time estimation unit 123 adds a timestamp indicating the transmission time point of the vehicle control signal to the vehicle control signal on the basis of the timer 127 and stores the vehicle control signal in a memory, which is not illustrated. Accordingly, a chronological history of vehicle control signals is recorded.

Note that the transmission time point of a vehicle control signal is approximately equal to the operation time point at which the remote driving operation corresponding to the vehicle control signal has been performed. Therefore, it is possible to consider the transmission time point of a vehicle control signal as the operation time point at which the corresponding remote driving operation has been performed.

In response to this, the vehicle control unit 212 of the vehicle 12 receives the vehicle control signal from the remote driving apparatus 11 via the communication unit 211.

In Step S9, the reaction force calculation unit 141 of the remote driving apparatus 11 calculates steering reaction force. For example, the reaction force calculation unit 141 calculates steering reaction force for the steering wheel 111 with a predetermined algorithm on the basis of the steering angle and steering speed of the steering wheel 111 by using the vehicle model 151, the environment model 152, and the model parameter 153. That is, the reaction force calculation unit 141 calculates steering reaction force to be applied to the steering wheel 111 in response to the operation of the steering wheel 111 by the remote driver. Further, the reaction force calculation unit 141 calculates steering reaction force torque to be applied to the steering shaft connected to the steering wheel 111, in order to apply the steering reaction force to the steering wheel 111.

In Step S10, the reaction force generation unit 125 generates steering reaction force. Specifically, the drive unit 142 controls the actuator and the like to apply the steering reaction force torque calculated by the reaction force calculation unit 141 to the steering shaft. Accordingly, the steering reaction force corresponding to the steering reaction force torque is generated and applied to the steering wheel 111 connected to the steering shaft, so that the steering reaction force is transmitted to the remote driver.

The reaction force generation unit 125 adds a timestamp indicating the generation time point at which the steering reaction force has been generated to data indicating the generated steering reaction force, on the basis of the timer 127, and records the data in a memory, which is not illustrated. Accordingly, a chronological history of steering reaction forces is recorded.

Note that the time point at which steering reaction force has been generated is approximately equal to the operation time point at which the steering wheel 111, which has been the target of steering reaction force generation, has been operated. Therefore, it is possible to consider the generation time point of steering reaction force as the operation time point of the steering wheel 111.

In Step S11, the vehicle 12 executes vehicle control processing.

Specifically, the action control unit 221 of the vehicle 12 controls the torque for the actuator configured to drive the steering shaft connected to the steering wheel 241, on the basis of the steering command included in the vehicle control signal. Accordingly, the steering angle and steering speed of the steering wheel 241 are controlled to approach as closely as possible the target values indicated by the steering command.

The action control unit 221 controls the torque for the actuator configured to drive the accelerator pedal 251, on the basis of the accelerator pedal command included in the vehicle control signal. Accordingly, the position of the accelerator pedal 251 is controlled to approach as closely as possible the target value indicated by the accelerator pedal command. Note that, for example, the action control unit 221 may instruct the motor with the drive torque corresponding to the target value indicated by the accelerator pedal command, without directly controlling the accelerator pedal 251.

The action control unit 221 controls the torque for the actuator configured to drive the brake pedal 252, on the basis of the brake command included in the vehicle control signal.

Accordingly, the pedal effort or position of the brake pedal 252 is controlled to approach as closely as possible the target value indicated by the brake pedal command. Note that, for example, the action control unit 221 may instruct the motor with the braking torque corresponding to the target value indicated by the brake pedal command, without directly controlling the brake pedal 252.

The action control unit 221 controls the body-system system 233 on the basis of the body-system command included in the vehicle control signal. Accordingly, each part of the body-system system 233 is controlled to execute the actions in accordance with the instructions indicated by the body-system command, to be set to the set values indicated by the body-system command, or to approach as closely as possible the target values indicated by the body-system command.

Here, there occurs action delay time mainly including (due to) the communication time (latency) between the remote driving apparatus 11 and the vehicle 12, from execution of the remote driving operation by the remote driver in the processing of Step S7 to execution of the action corresponding to the remote driving operation in the processing of Step S12. Further, the action delay time is not constant and fluctuates depending mainly on the communication status between the remote driving apparatus 11 and the vehicle 12.

In Step S12, the vehicle 12 executes state data collection processing.

For example, the speed-related sensor 261 detects the vehicle speed, the speed of each wheel, and the like. The speed-related sensor 261 supplies sensor data indicating the detection results to the information processing unit 201.

For example, the inertia sensor 262 detects the yaw rate and lateral acceleration of the vehicle body of the vehicle 12. The inertia sensor 262 supplies sensor data indicating the detection results to the information processing unit 201.

For example, the torque sensor 263 detects torque applied to the steering shaft connected to the steering wheel 241. The torque sensor 263 supplies sensor data indicating the detection result to the information processing unit 201.

For example, the steering angle-related sensor 264 detects the steering angle and steering angle speed of the steering wheel 241. The steering angle-related sensor 264 supplies sensor data indicating the detection results to the information processing unit 201.

For example, the acceleration and deceleration-related sensor 265 detects the acceleration and deceleration of the vehicle 12. The acceleration and deceleration-related sensor 265 supplies sensor data indicating the detection results to the information processing unit 201.

For example, the communication unit 211 detects the communication status (for example, a communication speed, a bandwidth, an error rate, and the like) with the remote driving apparatus 11 (for example, the network 13). The communication unit 211 supplies information indicating the detection results to the vehicle control unit 212.

For example, the acceleration and deceleration system 232 detects instructed acceleration or instructed deceleration, master cylinder pressure, and the like for the powertrain (not illustrated). The acceleration and deceleration system 232 supplies data indicating the detection results to the information processing unit 201.

For example, the state control unit 222 supplies information indicating the remote driving state of the vehicle 12 to the state data collection unit 223.

The state data collection unit 223 adds a timestamp indicating the acquisition time point (˜a detection time point) to each piece of acquired or calculated state data on the basis of the timer 214.

In Step S13, the vehicle 12 transmits vehicle state information. Specifically, the state data collection unit 223 generates vehicle state information that includes the timestamped state data acquired in the processing of Step S13 and indicates the state of the vehicle 12 and the state of the environment around the vehicle 12.

The vehicle state information includes, for example, steering information, inertia information, acceleration and acceleration torque information, deceleration and braking information, speed information, remote driving state, and communication status.

The steering information includes, for example, the steering angle, steering angle speed, steering reaction force torque or steering drive motor torque, and status of the steering wheel 241.

The inertia information includes, for example, the yaw rate, lateral acceleration, and status of the vehicle body of the vehicle 12.

The acceleration and acceleration torque information includes, for example, instructed acceleration to the powertrain of the vehicle 12 and the actual acceleration of the vehicle 12.

The deceleration and braking information includes, for example, master cylinder pressure and the actual deceleration and status of the vehicle 12.

The speed information includes, for example, the vehicle speed and the speed of each wheel.

The state data collection unit 223 transmits the vehicle state information to the remote driving apparatus 11 via the communication unit 211 and the network 13.

In response to this, the delay time estimation unit 123 and the parameter estimation unit 124 of the remote driving apparatus 11 receive the vehicle state information from the vehicle 12 via the network 13 and the communication unit 122.

Note that the processing of Step S12 and Step S13 is executed asynchronously with the processing of Step S9 and Step S10 (the processing of applying steering reaction force to the steering wheel 111 of the remote driving apparatus 11).

In Step S14, the remote driving apparatus 11 executes the estimation and update of model parameters.

Specifically, the delay time estimation unit 123 of the remote driving apparatus 11 estimates the action delay time between the remote driving apparatus 11 and the vehicle 12 on the basis of the chronological history of vehicle control signals recorded on the memory, which is not illustrated, and the vehicle state information received from the vehicle 12.

For example, the delay time estimation unit 123 estimates the relation between the transmission time point at which the vehicle control signal has been transmitted from the remote driving apparatus 11 and the time point at which the vehicle 12 has performed the action corresponding to the vehicle control signal (hereinafter referred to as an action time point), on the basis of the chronological transition of vehicle control signals based on the timestamps (transmission time points) of the vehicle control signals and the chronological transition of state data based on the timestamps (acquisition time points) of the state data included in the vehicle state information. Then, the delay time estimation unit 123 estimates an action delay time point on the basis of the time difference between the transmission time point of the vehicle control signal and the action time point at which the vehicle 12 has performed the action corresponding to the vehicle control signal.

Note that, as described above, it can be considered that the transmission time point of a vehicle control signal is approximately equal to the operation time point at which the remote driving operation corresponding to the vehicle control signal has been performed. Therefore, the delay time estimation unit 123 can estimate, for example, the time difference described above as the action delay time point as it is.

The delay time estimation unit 123 supplies information indicating the estimation result of the action delay time to the parameter estimation unit 124.

The parameter estimation unit 124 determines the difference between the steering reaction force applied to the steering wheel 111 by the reaction force generation unit 125 and the steering reaction force actually applied to the steering wheel 241 of the vehicle 12 or the steering reaction force torque estimated from the steering drive motor torque, on the basis of the chronological history of steering reaction forces recorded on the memory, which is not illustrated, and the vehicle state information received from the vehicle 12.

The acquisition time point indicated by the timestamp added to the steering reaction force (or the steering reaction force torque) for the steering wheel 241 included in the vehicle state information is hereinafter referred to as a time point t2. The steering reaction force torque at the time point t2 is, for example, steering reaction force torque actually applied to the steering wheel 241 in response to the remote operation on the steering wheel 241, the remote operation being based on the remote driving operation, and detected by the torque sensor 263 or steering reaction force torque calculated from the steering drive motor torque.

The parameter estimation unit 124 determines steering reaction force applied in response to the operation on the steering wheel 111 at a time point t1, which is the time point preceding the time point t2 by the action delay time, on the basis of the chronological data regarding steering reaction force for the steering wheel 111. Then, the parameter estimation unit 124 calculates the difference between the steering reaction force applied by the reaction force generation unit 125 in response to the remote driving operation on the steering wheel 111 at the time point t1 and the steering reaction force applied in response to the action (remote operation) of the steering wheel 241 corresponding the remote driving operation at the time point t2.

Then, the parameter estimation unit 124 estimates a road surface friction coefficient, which is an example of the model parameter 153, on the basis of the difference in actual vehicle motion. Further, the parameter estimation unit 124 estimates other parameters of the model parameter 153 such that the steering reaction force calculated by the reaction force calculation unit 141 on the basis of the steering angle and operation angle of the steering wheel 111 approaches the steering reaction force to be applied to the steering wheel 241 of the vehicle 12 after the delay time.

The parameter estimation unit 124 updates the current model parameter 153 of the reaction force calculation unit 141 with the estimated parameter.

Note that the processing of Step S14 is executed asynchronously with the processing of Step S9 and Step S10 (the processing of applying steering reaction force to the steering wheel 111 of the remote driving apparatus 11).

After that, the processing of Step S7 to Step S14 is repeatedly executed until the processing of Step S15 is executed. Accordingly, during the remote driving of the vehicle 12, the model parameter 153 is updated in real-time on the basis of the vehicle state information and the action delay time.

In Step S15, the remote driving apparatus 11 receives an end operation for remote driving.

For example, in a case where the remote driver ends the remote driving, the remote driver uses the switch group 114 of the remote driving apparatus 11 to perform an operation for ending remote driving.

In response to this, the switch group 114 supplies an operation signal instructing the end of remote driving to the vehicle control unit 121.

In Step S16, the remote driving apparatus 11 requests the vehicle 12 to end the remote driving. Specifically, the state control unit 135 generates a remote driving end request signal and transmits the remote driving end request signal to the vehicle 12 via the communication unit 122 and the network 13.

After that, the processing of the remote driving apparatus 11 ends.

In response to this, the vehicle control unit 121 of the vehicle 12 receives the remote driving end request signal from the remote driving apparatus 11 via the network 13 and the communication unit 211.

In Step S17, the state control unit 222 of the vehicle 12 executes remote driving end processing. For example, the state control unit 222 sets the vehicle 12 to a state in which the remote driving has been stopped.

After that, the processing of the vehicle 12 ends.

As described above, the steering reaction force calculated using the vehicle model 151 and the environment model 152 is applied to the steering wheel 111 without directly using the vehicle state information transmitted from the vehicle 12 with a delay. Therefore, a delay in the response of steering reaction force to an operation on the steering wheel 111 is prevented, so that the remote driver can execute remote driving with a steering feel similar to that of a normal vehicle, without feeling strangeness.

Further, the model parameter 153 is updated in real-time on the basis of the vehicle state information according to the condition of the road surface and the like. Accordingly, the steering reaction force for the steering wheel 111 is appropriately controlled to follow changes in the condition of the road surface and the like. That is, a more realistic steering reaction force is transmitted to the remote driver, regardless of changes in the condition of the road surface and the like.

Moreover, since time point synchronization is performed between the remote driving apparatus 11 and the vehicle 12, the remote driving apparatus 11 can accurately recognize the time point at which the state of the vehicle 12 and the situation around the vehicle 12 have been detected. Accordingly, changes in the state of the vehicle 12 and the situation around the vehicle 12 are accurately reflected in the model parameter 153.

Further, even in a state where communication between the remote driving apparatus 11 and the vehicle 12 is unstable and the communication time is fluctuating, changes in the state of the vehicle 12 and the situation around the vehicle 12 are accurately reflected in the model parameter 153.

Note that, for example, due to delays in communication between the remote driving apparatus 11 and the vehicle 12 and the like, a delay occurs in reflecting changes in the condition of the road surface in the model parameter 153. However, in general, changes in the condition of the road surface are mostly affected by weather such as rain or snow, and the time constant of such changes is very long. Therefore, even when there is a delay of several seconds in reflecting changes in the condition of the road surface in the model parameter 153, for example, it does not significantly affect the remote driving operation performed by the remote driver.

### 2. Modified Example

Now, a modified example of the embodiment of the present technology described above is described.

For example, one or more of the delay time estimation unit 123, the parameter estimation unit 124, and the reaction force calculation unit 141 may be provided separately from the remote driving apparatus 11. That is, one or more of the delay time calculation processing, the model parameter estimation processing, and the steering reaction force calculation processing may be executed by an external apparatus separate from the remote driving apparatus 11. This external apparatus may be, for example, a cloud system.

For example, the vehicle 12 may detect the friction coefficient of the road surface and include data indicating the detection result in vehicle state information.

For example, with a similar method, it is possible to apply the reaction force corresponding to the condition of the road surface and the like to the accelerator pedal 112 and the brake pedal 113 of the remote driving apparatus 11 by using the model and the model parameter and update the model parameter with vehicle state information.

### 3. Others

### Configuration Example of Computer

The series of processing described above can be executed by hardware or software. In a case where the series of processing is executed by software, a program configuring that software is installed on a computer. Here, examples of the computer include computers incorporated in dedicated hardware and, for example, general-purpose personal computers capable of executing various functions with various programs installed thereon.

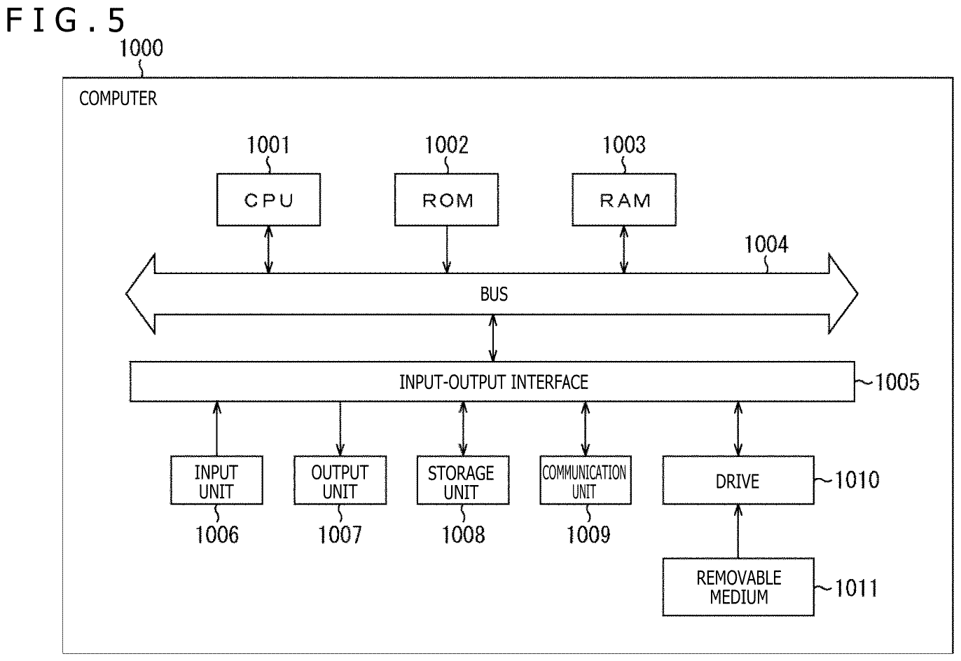

FIG. 5 is a block diagram illustrating a configuration example of the hardware of a computer configured to execute the above described series of processing by the program.

In a computer 1000, a CPU (Central Processing Unit) 1001, a ROM (Read Only Memory) 1002, and a RAM (Random Access Memory) 1003 are connected to each other through a bus 1004.

An input-output interface 1005 is further connected to the bus 1004. The input-output interface 1005 is connected to an input unit 1006, an output unit 1007, a storage unit 1008, a communication unit 1009, and a drive 1010.

The input unit 1006 includes an input switch, a button, a microphone, an imaging element, or the like. The output unit 1007 includes a display, a speaker, or the like. The storage unit 1008 includes a hard disk, a non-volatile memory, or the like. The communication unit 1009 includes a network interface or the like. The drive 1010 drives a removable medium 1011 such as a magnetic disk, an optical disc, a magneto-optical disk, or a semiconductor memory.

In the computer 1000 configured as described above, for example, the CPU 1001 loads the program recorded on the storage unit 1008 into the RAM 1003 through the input-output interface 1005 and the bus 1004 and executes the program to perform the series of processing described above.

The program to be executed by the computer 1000 (CPU 1001) can be recorded on the removable medium 1011, which serves as a package medium or the like, to be provided, for example. Further, the program can be provided via a wired or wireless transmission medium such as a local area network, the Internet, or digital satellite broadcasting.

In the computer 1000, the program can be installed on the storage unit 1008 through the input-output interface 1005 with the removable medium 1011 mounted on the drive 1010. Further, the program can be received by the communication unit 1009 via a wired or wireless transmission medium to be installed on the storage unit 1008. Besides, the program can be installed on the ROM 1002 or the storage unit 1008 in advance.

Note that the program to be executed by the computer may be a program whose processes are performed chronologically in the order described herein or in parallel. Alternatively, the program may be a program whose processes are performed at necessary timing such as when the program is called.

Further, the system herein means a set of multiple components (apparatuses, modules (parts), or the like), and it does not matter whether all the components are in the same housing or not. Therefore, multiple apparatuses accommodated in separate housings and connected to each other via a network and a single apparatus including multiple modules accommodated in a single housing are both systems.

Moreover, embodiments of the present technology are not limited to the embodiment described above, and various modifications can be made without departing from the gist of the present technology.

For example, the present technology can employ the configuration of cloud computing in which a single function is shared and collaboratively processed by multiple apparatuses via a network.

Further, each step of the flowchart described above can be executed by a single apparatus or can be shared and executed by multiple apparatuses.

Moreover, in a case where multiple processes are included in a single step, the multiple processes included in the single step can be executed by a single apparatus or can be shared and executed by multiple apparatuses.

### Examples of Combinations of Configurations

The present technology can also employ the following configurations.

(1)

An information processing apparatus including:
a delay time estimation unit configured to estimate, on the basis of vehicle state information, delay time occurring until a vehicle which is a target of remote driving executes, in response to a remote driving operation using an operation unit including a first steering wheel, an action corresponding to the remote driving operation, the vehicle state information including information from the vehicle, indicating a state related to the vehicle, and including one or more pieces of state data having added thereto a timestamp indicating an acquisition time point; and
a parameter estimation unit configured to estimate, on the basis of the vehicle state information and the delay time, a model parameter that includes a parameter of a model that is used in calculation of a first steering reaction force for the first steering wheel.
   (2)

The information processing apparatus according to (1) above, further including:
a reaction force calculation unit configured to calculate the first steering reaction force by using the model and the model parameter; and
a drive unit configured to generate the first steering reaction force to be applied to the first steering wheel, on the basis of a calculation result of the first steering reaction force.
   (3)

The information processing apparatus according to (2) above, in which
the reaction force calculation unit calculates the first steering reaction force by using the model and the model parameter on the basis of a steering angle and a steering speed of the first steering wheel.
   (4)

The information processing apparatus according to (2) or (3) above, further including:

the operation unit.

(5)

The information processing apparatus according to any one of (1) to (4) above, further including:
a time point synchronization unit configured to perform time point synchronization between a first timer and a second timer included in the vehicle, in which
the timestamp is added to the state data on the basis of the second timer, and
the delay time estimation unit estimates the delay time on the basis of an operation time point and a time point indicated by the timestamp added to the state data, the operation time point being a time point at which the remote driving operation has been performed and which is based on the first timer.
   (6)

The information processing apparatus according to (5) above, in which
the delay time estimation unit estimates an action time point which is a time point at which the vehicle has performed an action corresponding to the remote driving operation, on the basis of the state data and the timestamp, and estimates the delay time on the basis of a difference between the operation time point and the action time point.
   (7)

The information processing apparatus according to (6) above, in which
the vehicle state information includes data related to a second steering reaction force for a second steering wheel included in the vehicle, and
the parameter estimation unit estimates the model parameter on the basis of a difference between the first steering reaction force for an operation of the first steering wheel at the operation time point and the second steering reaction force for a remote operation of the second steering wheel at the action time point.
   (8)

The information processing apparatus according to any one of (1) to (7) above, in which
the parameter estimation unit updates the model parameter in real-time on the basis of the vehicle state information and the delay time during remote driving of the vehicle.
   (9)

The information processing apparatus according to any one of (1) to (8) above, including: a communication unit configured to communicate with the vehicle, transmit, to the vehicle, a vehicle control signal that includes control information regarding the vehicle and that is based on the remote driving operation, and receive the vehicle state information from the vehicle.

(10)

The information processing apparatus according to (9) above, further including:
a vehicle control unit configured to generate the vehicle control signal on the basis of the remote driving operation.
   (11)

The information processing apparatus according to (10) above, in which
the vehicle control signal includes control information associated with a remote operation of a second steering wheel included in the vehicle.
   (12)

The information processing apparatus according to (11) above, in which
the vehicle control signal includes control information indicating a steering angle and a steering speed of the second steering wheel.
   (13)

The information processing apparatus according to any one of (9) to (12) above, in which
the delay time includes communication time between the communication unit and the vehicle.
   (14)

The information processing apparatus according to any one of (1) to (13) above, in which
the model parameter includes a parameter indicating a condition of a road surface on which the vehicle travels.
   (15)

The information processing apparatus according to (14) above, in which
the model parameter includes a friction coefficient of the road surface.
   (16)

The information processing apparatus according to any one of (1) to (15) above, in which
the model includes a vehicle model that models the vehicle and an environment model that models an environment around the vehicle.
   (17)

The information processing apparatus according to (16) above, in which
the environment around the vehicle includes a condition of a road surface on which the vehicle travels.
   (18)

An information processing method including:
estimating, by an information processing apparatus, on the basis of vehicle state information, delay time occurring until a vehicle which is a target of remote driving executes, in response to a remote driving operation using an operation unit including a steering wheel, an action corresponding to the remote driving operation, the vehicle state information including information from the vehicle, indicating a state related to the vehicle, and including one or more pieces of state data having added thereto a timestamp indicating an acquisition time point; and
estimating, by the information processing apparatus, on the basis of the vehicle state information and the delay time, a model parameter that includes a parameter of a model that is used in calculation of steering reaction force for the steering wheel.
   (19)

A program for causing a computer to execute processing of:
estimating, on the basis of vehicle state information, delay time occurring until a vehicle which is a target of remote driving executes, in response to a remote driving operation using an operation unit including a steering wheel, an action corresponding to the remote driving operation, the vehicle state information including information from the vehicle, indicating a state related to the vehicle, and including one or more pieces of state data having added thereto a timestamp indicating an acquisition time point; and
estimating, on the basis of the vehicle state information and the delay time, a model parameter that includes a parameter of a model that is used in calculation of steering reaction force for the steering wheel.

Note that the effects described herein are merely exemplary and not limiting, and there may be other effects.

### REFERENCE SIGNS LIST

1: Remote driving system
11: Remote driving apparatus
12: Vehicle
13: Network
101: Operation unit
102: Information processing unit
111: Steering wheel
121: Vehicle control unit
122: Communication unit
123: Delay time estimation unit
124: Parameter estimation unit
125: Reaction force generation unit
126: Time point synchronization unit
127: Timer
131: Steering control unit
141: Reaction force calculation unit
142: Drive unit
151: Vehicle model
152: Environment model
153: Model parameter
201: Information processing unit
202: Action unit
203: Sensor unit
211: Communication unit
212: Vehicle control unit
213: Time point control unit
214: Timer
221: Action control unit
222: State control unit
223: State data collection unit
231: Steering system
241: Steering wheel
261: Speed-related sensor
262: Inertia sensor
263: Torque sensor
264: Steering angle-related sensor
265: Acceleration and deceleration-related sensor

1. An information processing apparatus comprising:
a delay time estimation unit configured to estimate, on a basis of vehicle state information, delay time occurring until a vehicle which is a target of remote driving executes, in response to a remote driving operation using an operation unit including a first steering wheel, an action corresponding to the remote driving operation, the vehicle state information including information from the vehicle, indicating a state related to the vehicle, and including one or more pieces of state data having added thereto a timestamp indicating an acquisition time point; and
a parameter estimation unit configured to estimate, on a basis of the vehicle state information and the delay time, a model parameter that includes a parameter of a model that is used in calculation of a first steering reaction force for the first steering wheel.

2. The information processing apparatus according to claim 1, further comprising:
a reaction force calculation unit configured to calculate the first steering reaction force by using the model and the model parameter; and
a drive unit configured to generate the first steering reaction force to be applied to the first steering wheel, on a basis of a calculation result of the first steering reaction force.

3. The information processing apparatus according to claim 2, wherein
the reaction force calculation unit calculates the first steering reaction force by using the model and the model parameter on a basis of a steering angle and a steering speed of the first steering wheel.

4. The information processing apparatus according to claim 2, further comprising:
the operation unit.

5. The information processing apparatus according to claim 1, further comprising:
a time point synchronization unit configured to perform time point synchronization between a first timer and a second timer included in the vehicle, wherein
the timestamp is added to the state data on a basis of the second timer, and
the delay time estimation unit estimates the delay time on a basis of an operation time point and a time point indicated by the timestamp added to the state data, the operation time point being a time point at which the remote driving operation has been performed and which is based on the first timer.

6. The information processing apparatus according to claim 5, wherein
the delay time estimation unit estimates an action time point which is a time point at which the vehicle has performed an action corresponding to the remote driving operation, on a basis of the state data and the timestamp, and estimates the delay time on a basis of a difference between the operation time point and the action time point.

7. The information processing apparatus according to claim 6, wherein
the vehicle state information includes data related to a second steering reaction force for a second steering wheel included in the vehicle, and
the parameter estimation unit estimates the model parameter on a basis of a difference between the first steering reaction force for an operation of the first steering wheel at the operation time point and the second steering reaction force for a remote operation of the second steering wheel at the action time point.

8. The information processing apparatus according to claim 1, wherein
the parameter estimation unit updates the model parameter in real-time on a basis of the vehicle state information and the delay time during remote driving of the vehicle.

9. The information processing apparatus according to claim 1, comprising:
a communication unit configured to communicate with the vehicle, transmit, to the vehicle, a vehicle control signal that includes control information regarding the vehicle and that is based on the remote driving operation, and receive the vehicle state information from the vehicle.

10. The information processing apparatus according to claim 9, further comprising:
a vehicle control unit configured to generate the vehicle control signal on a basis of the remote driving operation.

11. The information processing apparatus according to claim 10, wherein
the vehicle control signal includes control information associated with a remote operation of a second steering wheel included in the vehicle.

12. The information processing apparatus according to claim 11, wherein
the vehicle control signal includes control information indicating a steering angle and a steering speed of the second steering wheel.

13. The information processing apparatus according to claim 9, wherein
the delay time includes communication time between the communication unit and the vehicle.

14. The information processing apparatus according to claim 1, wherein
the model parameter includes a parameter indicating a condition of a road surface on which the vehicle travels.

15. The information processing apparatus according to claim 14, wherein
the model parameter includes a friction coefficient of the road surface.

16. The information processing apparatus according to claim 1, wherein
the model includes a vehicle model that models the vehicle and an environment model that models an environment around the vehicle.

17. The information processing apparatus according to claim 16, wherein
the environment around the vehicle includes a condition of a road surface on which the vehicle travels.

18. An information processing method comprising:
estimating, by an information processing apparatus, on a basis of vehicle state information, delay time occurring until a vehicle which is a target of remote driving executes, in response to a remote driving operation using an operation unit including a steering wheel, an action corresponding to the remote driving operation, the vehicle state information including information from the vehicle, indicating a state related to the vehicle, and including one or more pieces of state data having added thereto a timestamp indicating an acquisition time point; and
estimating, by the information processing apparatus, on a basis of the vehicle state information and the delay time, a model parameter that includes a parameter of a model that is used in calculation of steering reaction force for the steering wheel.

19. A program for causing a computer to execute processing of:
estimating, on a basis of vehicle state information, delay time occurring until a vehicle which is a target of remote driving executes, in response to a remote driving operation using an operation unit including a steering wheel, an action corresponding to the remote driving operation, the vehicle state information including information from the vehicle, indicating a state related to the vehicle, and including one or more pieces of state data having added thereto a timestamp indicating an acquisition time point; and
estimating, on a basis of the vehicle state information and the delay time, a model parameter that includes a parameter of a model that is used in calculation of steering reaction force for the steering wheel.
